(19) United States
(12) Patent Application Publication
(10) Pub. No.: US 2022/0053335 A1
(43) Pub. Date: Feb. 17, 2022

(54) METHOD FOR DETECTING AN ABNORMAL DEVICE, DEVICE AND STORAGE MEDIUM

(71) Applicant: Beijing Baidu Netcom Science Technology Co., Ltd., Beijing (CN)

(72) Inventors: Xiongfei TAN, Beijing (CN); Tingting GE, Beijing (CN); Xun GAN, Beijing (CN)

(73) Assignee: Beijing Baidu Netcom Science Technology Co., Ltd., Beijing (CN)

(21) Appl. No.: 17/511,810

(22) Filed: Oct. 27, 2021

(30) Foreign Application Priority Data
Jan. 29, 2021 (CN) 202110127434.8

(51) Int. Cl. H04W 12/122; H04W 4/80

(52) U.S. Cl. CPC H04W 12/122; H04W 4/80

(57) ABSTRACT

Provided are a method for detecting an abnormal device, a device and a storage medium, relating to the technical field of data processing and in particular to big data technologies. The scheme is as follows: acquiring target access data generated when a user terminal in a to-be-detected region runs a target application; where the target application provides a service based on a radio frequency signal sent by a radio frequency device arranged in the to-be-detected region; and performing anomaly detection on the radio frequency device according to the target access data.

### CROSS-REFERENCE TO RELATED APPLICATIONS

This application claims priority to Chinese patent application No. 202110127434.8 filed with the China National Intellectual Property Administration (CNIPA) on Jan. 29, 2021, the disclosure of which is incorporated herein by reference in its entirety.

### TECHNICAL FIELD

The present application relates to the technical field of data processing and in particular to big data technologies.

### BACKGROUND

With the continuous development of Internet technologies and communication technologies, user terminals, especially mobile terminals, are gradually applied in more fields. The user terminal usually needs to communicate with other devices or implement set functions such as positioning with the help of a radio frequency device arranged in the use environment. Therefore, the use experience of a terminal user will be seriously affected when the radio frequency device arranged in the use environment is abnormal.

In the related art, a gateway device is usually deployed when anomaly detection is performed on the radio frequency device, causing the high labor cost and material cost. Meanwhile, the accuracy of an anomaly detection result depends on the performance of the gateway device itself, so the reliability of the anomaly detection result cannot be ensured.

### SUMMARY

The present application provides a method for detecting an abnormal device, a device and a storage medium with lower cost and higher reliability of a detection result.

The present application provides a method for detecting an abnormal device. The method includes steps described below.

Target access data generated when a user terminal in a to-be-detected region runs a target application is acquired; where the target application provides a service based on a radio frequency signal sent by a radio frequency device arranged in the to-be-detected region.

Anomaly detection is performed on the radio frequency device according to the target access data.

The present application further provides an electronic device. The electronic device includes at least one processor and a memory.

The memory is communicatively connected to the at least one processor.

The memory stores an instruction executable by the at least one processor, and the instruction is executed by the at least one processor to cause the at least one processor to execute the method for detecting an abnormal device according to any embodiment of the present application.

The present application further provides a non-transitory computer-readable storage medium. The non-transitory computer-readable storage medium stores a computer instruction for causing a computer to execute the method for detecting an abnormal device according to any embodiment of the present application.

It is to be understood that the content described in this part is neither intended to identify key or important features of the embodiments of the present application nor intended to limit the scope of the present application. Other features of the present application are apparent from the description provided hereinafter.

### BRIEF DESCRIPTION OF DRAWINGS

The drawings are intended to provide a better understanding of the present scheme and not to limit the present application. In the drawings:

FIG. 1 is a flowchart of a method for detecting an abnormal device according to an embodiment of the present application;

FIG. 2 is a flowchart of another method for detecting an abnormal device according to an embodiment of the present application;

FIG. 3 is a flowchart of another method for detecting an abnormal device according to an embodiment of the present application;

FIG. 4 is a structure diagram of an apparatus for detecting an abnormal device according to an embodiment of the present application; and

FIG. 5 is a block diagram of an electronic device for implementing a method for detecting an abnormal device according to an embodiment of the present application.

### DETAILED DESCRIPTION

Example embodiments of the present application, including details of the embodiments of the present disclosure, are described hereinafter in conjunction with the drawings to facilitate understanding. The example embodiments are illustrative only. Therefore, it is to be understood by those of ordinary skill in the art that various changes and modifications may be made to the embodiments described herein without departing from the scope and spirit of the present application. Similarly, description of well-known functions and constructions is omitted hereinafter for clarity and conciseness.

Each method for detecting an abnormal device and each apparatus for detecting an abnormal device provided by the present application are suitable for the case of performing anomaly detection on a radio frequency device arranged in a to-be-detected region and configured to provide a radio frequency signal for a user terminal. Each method for detecting an abnormal device provided by the present application may be executed by an apparatus for detecting an abnormal device. The apparatus may be implemented by software and/or hardware and is configured in an electronic device.

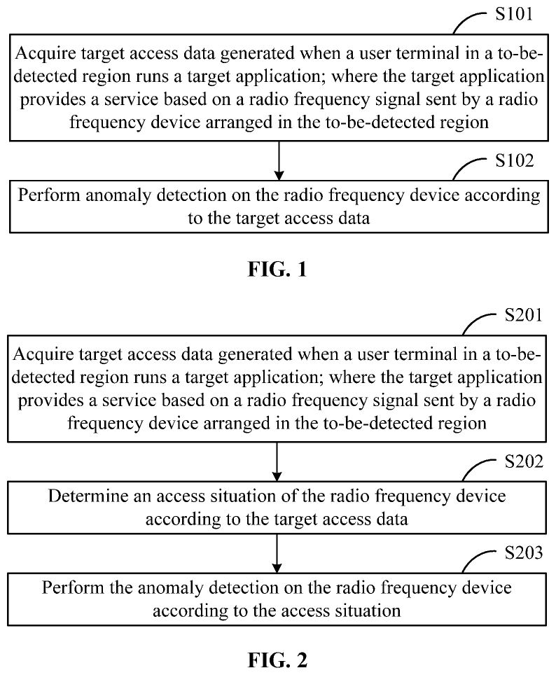

Referring to FIG. 1, a method for detecting an abnormal device includes steps described below.

In S101, target access data generated when a user terminal in a to-be-detected region runs a target application is acquired; where the target application provides a service based on a radio frequency signal sent by a radio frequency device arranged in the to-be-detected region.

The to-be-detected region is a place provided with at least one radio frequency device, for example, an indoor place such as a shopping mall, an office building, or a museum. The radio frequency device is a device for providing the radio frequency signal for the user terminal so as to provide a corresponding traffic service for a terminal user when the user terminal runs a target application. The target application is an application installed in the user terminal and used for providing a set function service. The number of to-be-detected regions may be at least one; the number of radio frequency devices arranged in each to-be-detected region may be at least one; the number of user terminals may be at least one, usually multiple; and the target application run by the user terminal may be at least one, usually one.

The target access data is used for characterizing an access request of the user terminal in at least one radio frequency device. Exemplarily, the target access data may include at least one of a device identifier of the radio frequency device, a signal strength of a received radio frequency signal, an access time, the number of historical accesses, or the like. It is to be understood that those skilled in the art may adjust the content category included in the target access data as required.

The target access data may be stored locally in the electronic device performing the method for detecting an abnormal device, other storage devices associated with the electronic device, or the cloud. Correspondingly, when detection of an abnormal device is required, the target access data is acquired from the corresponding storage position.

It is to be noted that the devices for collecting and storing the target access data may be the same or different devices. The device for collecting the target access data is usually a traffic server that supports the target application and provides a corresponding traffic service. The device for storing the target access data may be the traffic server itself, an electronic device for performing the method for detecting an abnormal device, or another device communicatively connected to the traffic server and the electronic device for performing the method for detecting an abnormal device.

In the to-be-detected region, the terminal user may use more than one application, such as a food application, a navigation application or an information application. In view of this, the process of acquiring the target access data will be described below in detail from the application level.

For ease of description, the application that the terminal user may use is referred to below as a candidate application; correspondingly, the target application is selected from a plurality of candidate applications, and target access data generated when the user in the to-be-detected region runs the target application is acquired.

In an alternative embodiment, at least one candidate application may be randomly selected from the plurality of candidate applications as the target application; and the target access data generated when the user terminal in the to-be-detected region runs the target application is acquired.

In different to-be-detected regions, the types of applications used by the terminal user are different and the frequency of using each application is also different, so accordingly, the amounts of generated target access data are also different. In order to ensure the amount of target access data and provide an enriched data support for the anomaly detection of the radio frequency device, in another alternative embodiment, the usage of a plurality of candidate applications used by a large number of terminal users in the to-be-detected region may be acquired in advance; the target application is selected from the plurality of candidate applications according to the usage; and the target access data generated when the user terminal in the to-be-detected region runs the target application is acquired. The usage may include at least one of the usage frequency, usage rate, audience figure, and the like of the candidate applications. Exemplarily, a candidate application having a relatively large number of audiences, a relatively high usage frequency, or a relatively high usage rate is selected as the target application.

In the preceding alternative embodiment, the usage of the candidate applications by the large number of terminal users needs to be determined in advance when the target application is selected, thus requiring a lot of labor cost and time cost to be invested. In order to save cost, improve the selection efficiency and convenience of the target application, and further reduce the difficulty in acquiring target access data and improve the data acquisition efficiency, in another alternative embodiment, the target application may also be selected from a plurality of candidate applications according to the place property of the to-be-detected region; and the target access data generated when the user terminal in the to-be-detected region runs the target application is acquired.

Exemplarily, a correspondence between different place properties and candidate applications may be established in advance; and the target application corresponding to the to-be-detected region is determined according to the correspondence. The correspondence between each place property and the candidate applications may be determined or adjusted by a technician according to needs or empirical values. For example, entertainment places correspond to short video applications or film and television applications, sports places correspond to fitness applications, humanities places correspond to navigation or explanation applications, office places correspond to communication or information applications, and the like. It is to be noted that the preceding correspondence is illustrative only, and those skilled in the art may make adjustments such as adding, deleting or modifying the preceding correspondence as required, which is not limited in the present application.

It is to be understood that the target application in the to-be-detected region may also be pre-specified by a technician as required before detection of an abnormal device is performed.

It is to be noted that there is usually no space limitation in the use of applications, that is, the terminal user may use the same application in different regions. In view of this, the process of acquiring the target access data will be described below in detail from the space level.

In an alternative embodiment, the step of acquiring the target access data generated when the user terminal in the to-be-detected region runs the target application may be as follows: determining initial access data generated when the user terminal runs the target application; and acquiring the target access data from the initial access data according to a region identifier of the to-be-detected region and/or a device identifier of the radio frequency device.

Exemplarily, a storage region of the initial access data generated when the user terminal runs the target application may be determined in a storage device of access data, where the initial access data includes access data of at least one region; and the target access data is searched and acquired from the initial access data of the storage region according to the region identifier of the to-be-detected region and/or the device identifier of the radio frequency device arranged in the to-be-detected region.

It is to be understood that the target access data is acquired through the region identifier and/or the device identifier without acquisition of other access data independent of the to-be-detected region, thereby reducing the amount of data transmission at the time of acquiring the access data and the storage space occupation of an electronic device performing the detection of an abnormal device.

It is to be noted that when the target applications of at least two to-be-detected regions are the same, target access data of the at least two to-be-detected regions may be acquired together from the initial access data directly according to region identifiers of the at least two to-be-detected regions and/or device identifiers of radio frequency devices arranged in the at least two to-be-detected regions, thereby laying the foundation for parallel determination or simultaneous determination of abnormal devices in the at least two to-be-detected regions.

In S102, anomaly detection is performed on the radio frequency device according to the target access data.

In an embodiment, an access situation of the radio frequency device is determined according to the target access data; and the anomaly detection is performed on the radio frequency device according to the access situation.

In an embodiment, the target access data is input into the trained anomaly detection model, and the anomaly detection is performed on the radio frequency device according to the output result of the model. A pre-constructed machine learning model is trained through anomaly label values and sample access data of a large amount of to-be-detected regions so that the anomaly detection model is obtained. The present application does not limit any model structure adopted by the machine learning model, and those skilled in the art may implement the model structure by using one or a combination of at least two machine learning models in the related art. For example, the machine learning model may be a neural network model.

According to the embodiment of the present application, the target application which provides a service based on the radio frequency signal sent by the radio frequency device arranged in the to-be-detected region is introduced and the target access data generated when the user terminal in the to-be-detected region runs the target application is acquired so that anomaly detection of the radio frequency device is performed. The present application provides a new anomaly detection mechanism in which access data is mined with the help of big data technologies such that the detection of an abnormal device is achieved. In the present application, a gateway system is not additionally needed to monitor the radio reference device so that technicians are not needed to deploy and maintain the gateway system, thus reducing the hardware cost and labor cost. Meanwhile, the detection process does not depend on the performance of the gateway system itself, so the detection result is more reliable.

In an alternative embodiment, the target application may be an application that provides a positioning service; the to-be-detected region may be a set region where the terminal user needs a positioning service such as indoor positioning; and correspondingly, the radio frequency device may be a hardware device arranged in the external environment of the to-be-detected region when the user terminal assists in positioning.

In an alternative embodiment, the radio frequency device may include at least one of: a Bluetooth device, a wireless fidelity (Wi-Fi) device, an ultra-wideband (UWB) device, a ZigBee device, a radio frequency identification (RFID) tag, or the like.

On the basis of the above technical schemes, the present application also provides an alternative embodiment. In the alternative embodiment, “performing anomaly detection on the radio frequency device according to target access data” is refined into “determining the access situation of the radio frequency device according to the target access data; and performing the anomaly detection on the radio frequency device according to the access situation”, so as to improve the anomaly detection mechanism of the radio frequency device.

Referring to FIG. 2, a method for detecting an abnormal device includes steps described below.

In S201, target access data generated when a user terminal in a to-be-detected region runs a target application is acquired; where the target application provides a service based on a radio frequency signal sent by a radio frequency device arranged in the to-be-detected region.

In S202, an access situation of the radio frequency device is determined according to the target access data.

In S203, the anomaly detection is performed on the radio frequency device according to the access situation.

The access situation may be at least one piece of information such as whether to access, the access frequency, and the signal strength.

In an alternative embodiment, it is possible to determine for each radio frequency device in the to-be-detected region, according to the target access data, whether a user terminal accesses the radio frequency device; if yes, it is determined that the radio frequency device is a normal device; otherwise, it is determined that the radio frequency device is an abnormal device.

When few terminal users go to the to-be-detected region, the accuracy of the detection result is not high if the detection of an abnormal device is performed only through whether the user terminal accesses or not, and the radio frequency signal sent by the radio frequency device may be weak due to the anomaly of the radio frequency device itself, so abnormal devices may miss the identification. In order to further improve the accuracy of the detection result of an abnormal device, in another alternative embodiment, statistics may further be performed on the target access data in a set period according to the device identifier of the radio frequency device; an access frequency of the radio frequency device is determined according to a statistical result; and whether the radio frequency device is abnormal is determined according to the access frequency and a set frequency threshold.

The set period and the set frequency threshold may be determined by a technician according to needs or empirical values or repeatedly determined or adjusted by a large number of trials.

Exemplarily, one of undetected radio frequency devices may be acquired from a list of radio frequency devices in the to-be-detected region; the access frequency of the one radio frequency device is determined according to the number of accesses of user terminals in the target access data in the set period; if the access frequency is less than the set frequency threshold, the radio frequency device is determined as an abnormal device; otherwise, the radio frequency device is determined as a normal device; and the operation of acquiring the undetected radio frequency device is returned to until the detection of each radio frequency device in the list of radio frequency devices in the to-be-detected region is completed.

Exemplarily, the device identifier of each radio frequency device of a radio frequency device category in the to-be-detected region may also be a statistical field, and the statistical operation of the target access data of each radio frequency device is completed at one time to obtain the access frequency statistical result of each radio frequency device; the access frequency of each radio frequency device is compared with the set frequency threshold respectively; a radio frequency device whose comparison result is that the access frequency is less than the set frequency threshold is determined as an abnormal device, and a radio frequency device whose comparison result is that the access frequency is not less than the set frequency threshold is determined as a normal device.

According to the embodiment of the present application, the anomaly detection operation of a radio frequency device is refined into determining the access situation of the radio frequency device according to target access data and performing anomaly detection on the radio frequency device according to the access situation. The above technical scheme is convenient and quick to operate, improving the detection efficiency. In addition, the above scheme does not need to depend on the trained machine learning model, so it is not necessary to invest a lot of labor cost and time cost to collect training samples and train the machine learning model, further reducing the cost of detection of an abnormal device.

On the basis of the above technical schemes, the present application also provides an alternative embodiment in which the anomaly detection is performed on each Bluetooth device arranged in an indoor positioning scenario. Of course, the Bluetooth device is merely used as an example in the embodiment of the present application and should not be understood as limiting the radio frequency device.

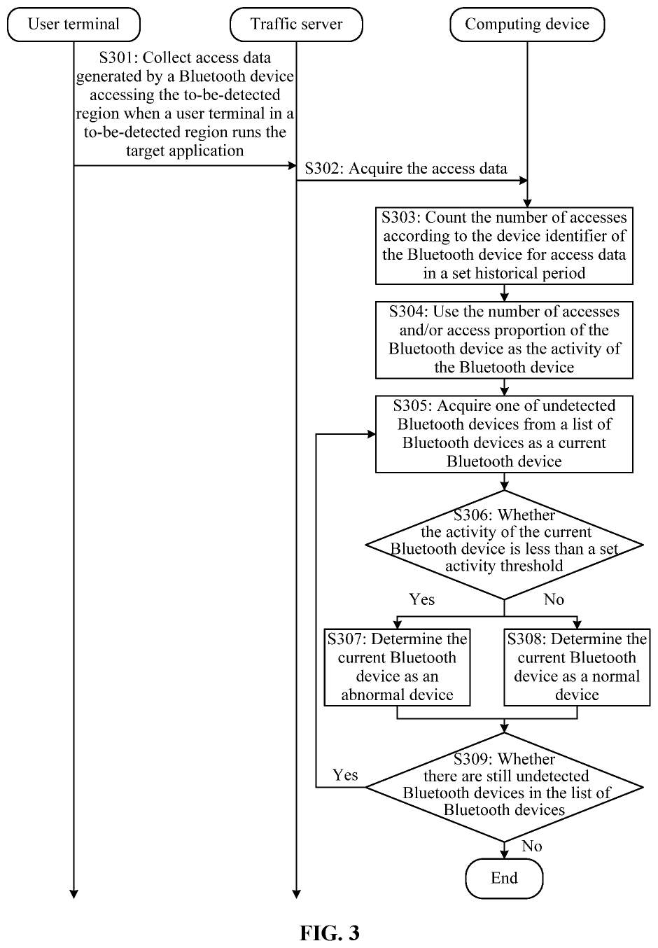

Referring to FIG. 3, a method for detecting an abnormal device includes steps described below.

In S301, when a terminal user uses a target application in a to-be-detected region, a traffic server of the target application collects access data generated by a Bluetooth device accessing the to-be-detected region when each user terminal runs the target application.

The access data includes the device identifier of the accessed Bluetooth device for subsequent statistics of the number of accesses.

In S302, a computing device acquires access data from the traffic server.

In S303, the computing device counts the number of accesses according to the device identifier of the Bluetooth device for the access data in a set historical period.

The set historical period may be determined by a technician according to needs or empirical values, for example, one week.

In S304, the number of accesses and/or access proportion of the Bluetooth device is used as the activity of the Bluetooth device.

In S305, one of undetected Bluetooth devices is acquired from a list of Bluetooth devices as a current Bluetooth device.

In S306, it is determined whether the activity of the current Bluetooth device is less than a set activity threshold; if yes, S307 is performed; otherwise, S308 is performed.

The set activity threshold may be determined or adjusted by a technician according to needs or empirical values. For example, the set activity threshold may be determined according to the foot traffic of the to-be-detected region in the set historical period.

In S307, the current Bluetooth device is determined as an abnormal device; and S309 continues to be performed.

In S308, the current Bluetooth device is determined as a normal device.

In S309, it is determined whether there are still undetected Bluetooth devices in the list of Bluetooth devices; if yes, S305 is returned; otherwise, the process ends.

According to the present application, the access data in the traffic server is reused, and the access data is mined with the help of the big data idea, thus achieving the detection of an abnormal Bluetooth device. There is no need to set up a dedicated gateway system to monitor the Bluetooth signal transmission condition of the Bluetooth device, reducing the detection cost of an abnormal device. Meanwhile, there is no need to depend on the performance of the gateway system itself, making the anomaly detection result more reliable.

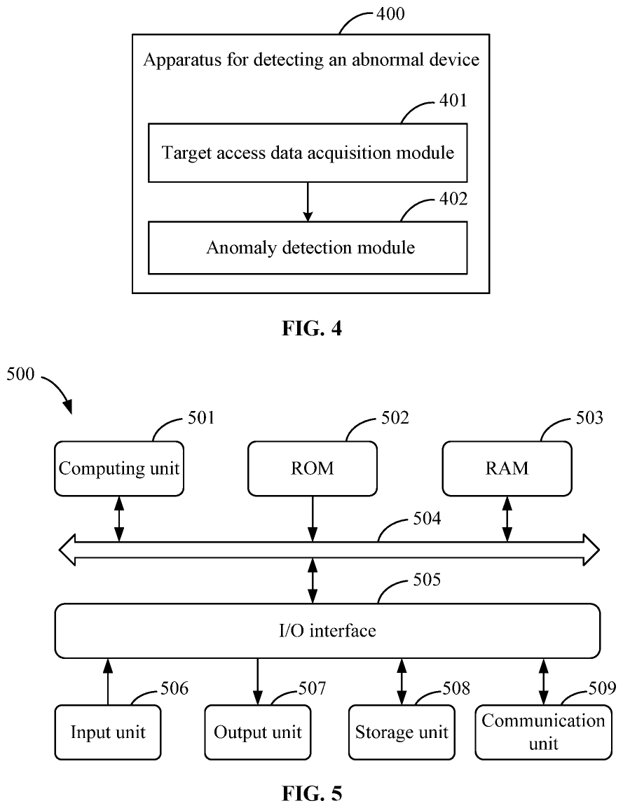

To implement the above-mentioned methods for detecting an abnormal device, the present application also provides an alternative embodiment of a virtual device implementing the method for detecting an abnormal device. With further reference to FIG. 4, an apparatus for detecting an abnormal device 400 includes a target access data acquisition module 401 and an anomaly detection module 402.

The target access data acquisition module 401 is configured to acquire target access data generated when a user terminal in a to-be-detected region runs a target application. The target application provides a service based on a radio frequency signal sent by a radio frequency device arranged in the to-be-detected region.

The anomaly detection module 402 is configured to perform anomaly detection on the radio frequency device according to the target access data.

According to the embodiment of the present application, a target application which provides a service based on the radio frequency signal sent by the radio frequency device arranged in the to-be-detected region is introduced and the target access data generated when the user terminal in the to-be-detected region runs the target application is acquired so that anomaly detection of the radio frequency device is performed. The present application provides a new anomaly detection mechanism in which access data is mined with the help of big data technologies such that the detection of an abnormal device is achieved. In the present application, a gateway system is not additionally needed to monitor the radio reference device so that technicians are not needed to deploy and maintain the gateway system, thus reducing hardware cost and labor cost. Meanwhile, the detection process does not depend on the performance of the gateway system itself, so the detection result is more reliable.

In an alternative embodiment, the target access data acquisition module 401 includes a target application selection unit and a target access data acquisition unit.

The target application selection unit is configured to select the target application from a plurality of candidate applications according to a place property of the to-be-detected region.

The target access data acquisition unit is configured to acquire the target access data generated when the user terminal in the to-be-detected region runs the target application.

In an alternative embodiment, the target access data acquisition module 401 includes an initial access data determination unit and a target access data acquisition unit.

The initial access data determination unit is configured to determine initial access data generated when the user terminal runs the target application.

The target access data acquisition unit is configured to acquire the target access data from the initial access data according to a region identifier of the to-be-detected region and/or a device identifier of the radio frequency device.

In an alternative embodiment, the anomaly detection module 402 includes an access situation determination unit and an anomaly detection unit.

The access situation determination unit is configured to determine an access situation of the radio frequency device according to the target access data.

The anomaly detection unit is configured to perform the anomaly detection on the radio frequency device according to the access situation.

In an alternative embodiment, the access situation determination unit includes a statistics sub-unit and an access frequency determination sub-unit.

The statistics sub-unit is configured to perform statistics on the target access data in a set period according to the device identifier of the radio frequency device.

The access frequency determination sub-unit is configured to determine an access frequency of the radio frequency device according to a statistical result.

The anomaly detection unit includes an anomaly detection sub-unit.

The anomaly detection sub-unit is configured to determine whether the radio frequency device is abnormal according to the access frequency and a set frequency threshold.

In an alternative embodiment, the target application is an application providing a positioning service.

In an alternative embodiment, the radio frequency device includes at least one of: a Bluetooth device, a wireless fidelity (Wi-Fi) device, an ultra-wideband (UWB) device, a ZigBee device, or a radio frequency identification (RFID) tag.

The apparatus for detecting an abnormal device may perform any method for detecting an abnormal device provided by the embodiment of the present application and has corresponding functional modules and beneficial effects for performing the method for detecting an abnormal device.

According to the embodiments of the present application, the present application further provides an electronic device, a readable storage medium and a computer program product.

FIG. 5 shows a block diagram illustrative of an exemplary electronic device 500 that may be used for implementing the embodiments of the present application. Electronic devices are intended to represent various forms of digital computers, for example, laptop computers, desktop computers, worktables, personal digital assistants, servers, blade servers, mainframe computers and other applicable computers. Electronic devices may also represent various forms of mobile devices, for example, personal digital assistants, cellphones, smartphones, wearable devices and other similar computing devices. Herein the shown components, the connections and relationships between these components, and the functions of these components are illustrative only and are not intended to limit the implementation of the present application as described and/or claimed herein.

As shown in FIG. 5, the device 500 includes a computing unit 501. The computing unit 501 may perform various appropriate actions and processing according to a computer program stored in a read-only memory (ROM) 502 or a computer program loaded into a random-access memory (RAM) 503 from a storage unit 508. The RAM 503 may also store various programs and data required for operations of the device 500. The computing unit 501, the ROM 502 and the RAM 503 are connected to each other by a bus 504. An input/output (I/O) interface 505 is also connected to the bus 504.

Multiple components in the device 500 are connected to the I/O interface 505. The multiple components include an input unit 506 such as a keyboard or a mouse, an output unit 507 such as various types of displays or speakers, the storage unit 508 such as a magnetic disk or an optical disk, and a communication unit 509 such as a network card, a modem or a wireless communication transceiver. The communication unit 509 allows the device 500 to exchange information/data with other devices over a computer network such as the Internet and/or over various telecommunication networks.

The computing unit 501 may be a general-purpose and/or special-purpose processing component having processing and computing capabilities. Examples of the computing unit 501 include, but are not limited to, a central processing unit (CPU), a graphics processing unit (GPU), a special-purpose artificial intelligence (AI) computing chip, a computing unit executing machine learning model algorithms, a digital signal processor (DSP) and any appropriate processor, controller and microcontroller. The computing unit 501 performs various methods and processing described above, such as the method for detecting an abnormal device. For example, in some embodiments, the method for detecting an abnormal device may be implemented as a computer software program tangibly contained in a machine-readable medium such as the storage unit 508. In some embodiments, part or all of computer programs may be loaded and/or installed on the device 500 via the ROM 502 and/or the communication unit 509. When the computer program is loaded to the RAM 503 and executed by the computing unit 501, one or more steps of the preceding method for detecting an abnormal device may be performed. Alternatively, in other embodiments, the computing unit 501 may be configured, in any other suitable manner (for example, by means of firmware), to perform the method for detecting an abnormal device.

Herein various embodiments of the systems and techniques described above may be implemented in digital electronic circuitry, integrated circuitry, field-programmable gate arrays (FPGAs), application-specific integrated circuits (ASICs), application-specific standard products (ASSPs), systems on chips (SoCs), complex programmable logic devices (CPLDs), and computer hardware, firmware, software and/or combinations thereof. The various embodiments may include implementations in one or more computer programs. The one or more computer programs are executable and/or interpretable on a programmable system including at least one programmable processor. The programmable processor may be a special-purpose or general-purpose programmable processor for receiving data and instructions from a memory system, at least one input device and at least one output device and transmitting data and instructions to the memory system, the at least one input device and the at least one output device.

Program codes for implementation of the method of the present application may be written in any combination of one or more programming languages. These program codes may be provided for the processor or controller of a general-purpose computer, a special-purpose computer or another programmable data processing device to enable functions/operations specified in a flowchart and/or a block diagram to be implemented when the program codes are executed by the processor or controller. The program codes may all be executed on a machine; may be partially executed on a machine; may serve as a separate software package that is partially executed on a machine and partially executed on a remote machine; or may all be executed on a remote machine or a server.

In the context of the present disclosure, the machine-readable medium may be a tangible medium that contains or stores a program available for an instruction execution system, apparatus or device or a program used in conjunction with an instruction execution system, apparatus or device. The machine-readable medium may be a machine-readable signal medium or a machine-readable storage medium. The machine-readable medium may include, but is not limited to, an electronic, magnetic, optical, electromagnetic, infrared or semiconductor system, apparatus or device, or any appropriate combination thereof. Concrete examples of the machine-readable storage medium may include an electrical connection based on one or more wires, a portable computer disk, a hard disk, a random-access memory (RAM), a read-only memory (ROM), an erasable programmable read-only memory (EPROM) or a flash memory, an optical fiber, a portable compact disc read-only memory (CD-ROM), an optical storage device, a magnetic storage device, or any appropriate combination thereof.

In order that interaction with a user is provided, the systems and techniques described herein may be implemented on a computer. The computer has a display device (for example, a cathode-ray tube (CRT) or liquid-crystal display (LCD) monitor) for displaying information to the user; and a keyboard and a pointing device (for example, a mouse or a trackball) through which the user may provide input for the computer. Other types of devices may also be used for providing interaction with a user. For example, feedback provided for the user may be sensory feedback in any form (for example, visual feedback, auditory feedback or haptic feedback). Moreover, input from the user may be received in any form (including acoustic input, voice input or haptic input).

The systems and techniques described herein may be implemented in a computing system including a back-end component (for example, a data server), a computing system including a middleware component (for example, an application server), a computing system including a front-end component (for example, a client computer having a graphical user interface or a web browser through which a user may interact with implementations of the systems and techniques described herein) or a computing system including any combination of such back-end, middleware or front-end components. The components of the system may be interconnected by any form or medium of digital data communication (for example, a communication network). Examples of the communication network include a local area network (LAN), a wide area network (WAN), a blockchain network and the Internet.

The computer system may include applications and servers. An application and a server are generally remote from each other and typically interact through a communication network. The relationship between the application and the server arises by virtue of computer programs running on the respective computers and having an application-server relationship to each other. The server may be a cloud server, also referred to as a cloud computing server or a cloud host. As a host product in a cloud computing service system, the server solves the defects of difficult management and weak traffic scalability in a related physical host and a related virtual private server (VPS) service. The server may also be a server of a distributed system, or a server combined with blockchain.

It is to be understood that various forms of the preceding flows may be used, with steps reordered, added or removed. For example, the steps described in the present application may be executed in parallel, in sequence or in a different order as long as the desired result of the technical scheme disclosed in the present application is achieved. The execution sequence of these steps is not limited herein.

The scope of the present application is not limited to the preceding embodiments. It is to be understood by those skilled in the art that various modifications, combinations, sub-combinations and substitutions may be made depending on design requirements and other factors. Any modifications, equivalent substitutions, improvements and the like made within the spirit and principle of the present application are within the scope of the present application.

What is claimed is:

1. A method for detecting an abnormal device, comprising:
acquiring target access data generated when a user terminal in a to-be-detected region runs a target application; wherein the target application provides a service based on a radio frequency signal sent by a radio frequency device arranged in the to-be-detected region; and
performing anomaly detection on the radio frequency device according to the target access data.

2. The method of claim 1, wherein acquiring the target access data generated when the user terminal in the to-be-detected region runs the target application comprises:
selecting the target application from a plurality of candidate applications according to a place property of the to-be-detected region; and
acquiring the target access data generated when the user terminal in the to-be-detected region runs the target application.

3. The method of claim 1, wherein acquiring the target access data generated when the user terminal in the to-be-detected region runs the target application comprises:
determining initial access data generated when the user terminal runs the target application; and
acquiring the target access data from the initial access data according to at least one of a region identifier of the to-be-detected region or a device identifier of the radio frequency device.

4. The method of claim 1, wherein performing the anomaly detection on the radio frequency device according to the target access data comprises:
determining an access situation of the radio frequency device according to the target access data; and
performing the anomaly detection on the radio frequency device according to the access situation.

5. The method of claim 4, wherein determining the access situation of the radio frequency device according to the target access data comprises:
performing statistics on the target access data in a set period according to the device identifier of the radio frequency device; and
determining an access frequency of the radio frequency device according to a statistical result; and
wherein performing the anomaly detection on the radio frequency device according to the access situation comprises:
determining whether the radio frequency device is abnormal according to the access frequency and a set frequency threshold.

6. The method of claim 1, wherein the target application is an application providing a positioning service.

7. The method of claim 6, wherein the radio frequency device comprises at least one of: a Bluetooth device, a wireless fidelity (Wi-Fi) device, an ultra-wideband (UWB) device, a ZigBee device, or a radio frequency identification (RFID) tag.

8. An electronic device, comprising:
at least one processor; and
a memory communicatively connected to the at least one processor;
wherein the memory stores an instruction executable by the at least one processor, and the instruction is executed by the at least one processor to cause the at least one processor to execute:
acquiring target access data generated when a user terminal in a to-be-detected region runs a target application; wherein the target application provides a service based on a radio frequency signal sent by a radio frequency device arranged in the to-be-detected region; and
performing anomaly detection on the radio frequency device according to the target access data.

9. The electronic device of claim 8, wherein the instruction is executed by the at least one processor to cause the at least one processor to execute acquiring the target access data generated when the user terminal in the to-be-detected region runs the target application by:
selecting the target application from a plurality of candidate applications according to a place property of the to-be-detected region; and
acquiring the target access data generated when the user terminal in the to-be-detected region runs the target application.

10. The electronic device of claim 8, wherein the instruction is executed by the at least one processor to cause the at least one processor to execute acquiring the target access data generated when the user terminal in the to-be-detected region runs the target application by:
determining initial access data generated when the user terminal runs the target application; and
acquiring the target access data from the initial access data according to at least one of a region identifier of the to-be-detected region or a device identifier of the radio frequency device.

11. The electronic device of claim 8, wherein the instruction is executed by the at least one processor to cause the at least one processor to execute performing the anomaly detection on the radio frequency device according to the target access data by:
determining an access situation of the radio frequency device according to the target access data; and
performing the anomaly detection on the radio frequency device according to the access situation.

12. The electronic device of claim 11, wherein the instruction is executed by the at least one processor to cause the at least one processor to execute determining the access situation of the radio frequency device according to the target access data by:
performing statistics on the target access data in a set period according to the device identifier of the radio frequency device; and
determining an access frequency of the radio frequency device according to a statistical result; and
wherein the instruction is executed by the at least one processor to cause the at least one processor to execute performing the anomaly detection on the radio frequency device according to the access situation by:
determining whether the radio frequency device is abnormal according to the access frequency and a set frequency threshold.

13. The electronic device of claim 8, wherein the target application is an application providing a positioning service.

14. The electronic device of claim 13, wherein the radio frequency device comprises at least one of: a Bluetooth device, a wireless fidelity (Wi-Fi) device, an ultra-wideband (UWB) device, a ZigBee device, or a radio frequency identification (RFID) tag.

15. A non-transitory computer-readable storage medium storing a computer instruction; wherein the computer instruction is configured to cause a computer to execute:
acquiring target access data generated when a user terminal in a to-be-detected region runs a target application; wherein the target application provides a service based on a radio frequency signal sent by a radio frequency device arranged in the to-be-detected region; and
performing anomaly detection on the radio frequency device according to the target access data.

16. The storage medium of claim 15, wherein the computer instruction is configured to cause the computer to execute acquiring the target access data generated when the user terminal in the to-be-detected region runs the target application by:
selecting the target application from a plurality of candidate applications according to a place property of the to-be-detected region; and
acquiring the target access data generated when the user terminal in the to-be-detected region runs the target application.

17. The storage medium of claim 15, wherein the computer instruction is configured to cause the computer to execute acquiring the target access data generated when the user terminal in the to-be-detected region runs the target application by:
determining initial access data generated when the user terminal runs the target application; and
acquiring the target access data from the initial access data according to at least one of a region identifier of the to-be-detected region or a device identifier of the radio frequency device.

18. The storage medium of claim 15, wherein the computer instruction is configured to cause the computer to execute performing the anomaly detection on the radio frequency device according to the target access data by:
determining an access situation of the radio frequency device according to the target access data; and
performing the anomaly detection on the radio frequency device according to the access situation.

19. The storage medium of claim 18, wherein the computer instruction is configured to cause the computer to execute determining the access situation of the radio frequency device according to the target access data by:
performing statistics on the target access data in a set period according to the device identifier of the radio frequency device; and
determining an access frequency of the radio frequency device according to a statistical result; and
wherein the computer instruction is configured to cause the computer to execute performing the anomaly detection on the radio frequency device according to the access situation by:
determining whether the radio frequency device is abnormal according to the access frequency and a set frequency threshold.

20. A computer program product, comprising a computer program which, when executed by a processor, implements the method for detecting an abnormal device of claim 1.
